(19) United States
(12) Patent Application Publication
(10) Pub. No.: US 2011/0187937 A1
(43) Pub. Date: Aug. 4, 2011

(54) METHOD FOR FREQUENCY COMPENSATION AND RELATED APPARATUS

(76) Inventors: Shiang-Lun Kao, Tainan County (TW); Tien-Ju Tsai, Tainan County (TW)

(21) Appl. No.: 12/699,060

(22) Filed: Feb. 3, 2010

(51) Int. Cl. H04N 5/44; H04B 1/18

(52) U.S. Cl. 348/725; 455/192.1; 348/E05.096

(57) ABSTRACT

A method for frequency compensation includes the following steps: detecting and checking if a desired frequency falls within a first detectable frequency range delimited by an initial frequency and a first specific frequency; and when the desired frequency exceeds the first detectable frequency range, utilizing a first frequency compensation step with a step size greater than a size of the first detectable frequency range for shifting the initial frequency to a first adjusted frequency beyond the first specific frequency in a first direction.

### BACKGROUND OF THE INVENTION

1. Field of the Invention

The present invention relates to frequency compensation, and more particularly, to a frequency compensation method which can compensate a frequency in a flexible manner, and a related apparatus.

2. Description of the Prior Art

In modern television (TV) systems which utilize analog modulation techniques, the television system will perform an auto detection operation to derive a standard audio frequency in each band, and then a receiver of the television system sets carrier frequency and analyzes TV signals according to the standard audio frequency. However, the TV signal may have a frequency offset, resulting in an auto detection failure or an erroneous judgment of the standard audio frequency. Additionally, the receiver usually utilizes an auto frequency compensation mechanism to compensate the audio frequency dynamically. If the frequency offset increases, the frequency compensation time of the TV signal will be longer, causing discomfort to the user's hearing. Therefore, there is a need to provide a rapid frequency compensation method that can be operated in the receiver of the TV system.

### SUMMARY OF THE INVENTION

It is therefore one of the objectives of the present invention to provide a frequency compensation method which can compensate a frequency in a flexible manner, and a related apparatus, to solve the above mentioned problems.

According to an embodiment of the present invention, an exemplary method for frequency compensation is disclosed. The exemplary method includes the following steps: detecting and checking if a desired frequency falls within a first detectable frequency range delimited by an initial frequency and a first specific frequency; and when the desired frequency exceeds the first detectable frequency range, utilizing a first frequency compensation step with a step size greater than a size of the first detectable frequency range for shifting the initial frequency to a first adjusted frequency beyond the first specific frequency in a first direction.

According to another embodiment of the present invention, an exemplary frequency compensation apparatus is provided. The exemplary frequency compensation apparatus includes a detecting unit and a compensation unit. The detecting unit is used for detecting and checking if a desired frequency falls within a first detectable frequency range delimited by an initial frequency and a first specific frequency to generate a first detecting result. The compensation unit is coupled to the detecting unit, and implemented for compensating the initial frequency to a first adjusted frequency according to the first detecting result generated by the detecting unit. When the first detecting result indicates that the desired frequency exceeds the first detectable frequency range, the compensation unit utilizes a first frequency compensation step with a step size greater than a size of the first detectable frequency range for shifting the initial frequency to the first adjusted frequency beyond the first specific frequency in a first direction.

According to another embodiment of the present invention, an exemplary method for frequency compensation is disclosed. The exemplary method includes the following steps: detecting and checking if a desired frequency falls within a detectable frequency range, wherein an initial frequency is located at a center of the detectable frequency range; and when the desired frequency exceeds the detectable frequency range, utilizing a frequency compensation step with a step size greater than a half size of the detectable frequency range for updating the initial frequency by shifting the initial frequency to an adjusted frequency.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart illustrating a method for frequency compensation according to an exemplary embodiment of the present invention.

FIG. 2 is a diagram illustrating a frequency compensation apparatus according to an exemplary embodiment of the present invention.

FIG. 3 is a flowchart illustrating a method for frequency compensation according to an exemplary embodiment of the present invention.

FIG. 4 is a sequence diagram illustrating a frequency compensation procedure according to a first exemplary embodiment of the present invention.

FIG. 5 is a sequence diagram illustrating a frequency compensation procedure according to a second exemplary embodiment of the present invention.

FIG. 6 is a sequence diagram illustrating a frequency compensation procedure according to a third exemplary embodiment of the present invention.

FIG. 7 is a sequence diagram illustrating a frequency compensation procedure according to a fourth exemplary embodiment of the present invention.

### DETAILED DESCRIPTION

Certain terms are used throughout the following description and claims to refer to particular components. As one skilled in the art will appreciate, hardware manufacturers may refer to a component by different names. This document does not intend to distinguish between components that differ in name but in function. In the following discussion and in the claims, the terms “include”, “including”, “comprise”, and “comprising” are used in an open-ended fashion, and thus should be interpreted to mean “including, but not limited to . . . ”. The terms “couple” and “coupled” are intended to mean either an indirect or a direct electrical connection. Thus, if a first device couples to a second device, that connection may be through a direct electrical connection, or through an indirect electrical connection via other devices and connections.

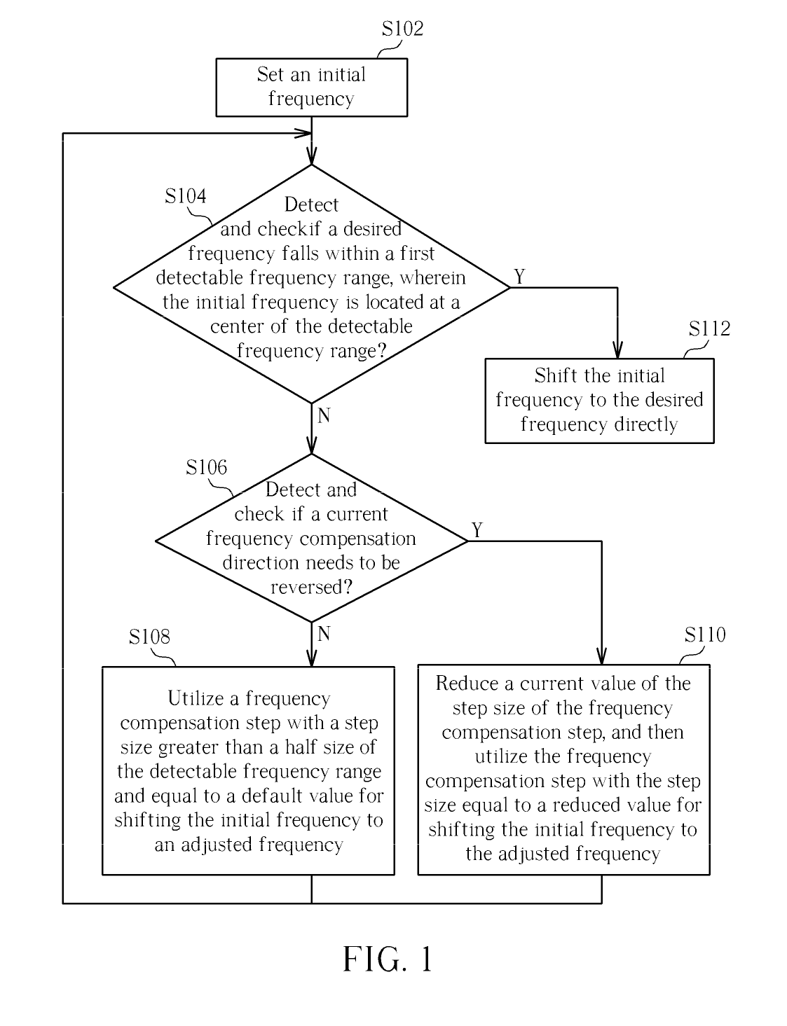

Please refer to FIG. 1. FIG. 1 is a flowchart illustrating a method for frequency compensation according to an exemplary embodiment of the present invention. Please note that, provided the same result is substantially achieved, the steps of the flow shown in FIG. 1 need not be in the exact order shown and need not be contiguous; that is, other steps can be intermediate. The exemplary method for frequency compensation includes the following steps:

Step 102: set an initial frequency Fᵢₙᵢ.

Step 104: detect and check if a desired frequency F_{de} falls within a detectable frequency range R, wherein the initial frequency Fᵢₙᵢ is located at a center of the detectable frequency range R. If yes, go to step 112; otherwise, go to step 106.

Step 106: detect and check if a current frequency compensation direction D needs to be reversed. If yes, go to step 110; otherwise, go to step 108.

Step 108: utilize a frequency compensation step S_{fc} with a step size greater than a half size of the detectable frequency range R and equal to a default value Vd for shifting the initial frequency Fᵢₙᵢ to an adjusted frequency F_{adj}, and then go to step 104.

Step 110: reduce a current value of the step size of the frequency compensation step S_{fc}, and then utilize the frequency compensation step S_{fc} with the step size equal to a reduced value Vr for shifting the initial frequency Fᵢₙᵢ to the adjusted frequency F_{adj}, and then go to step 104.

Step 112: shift the initial frequency Fᵢₙᵢ to the desired frequency F_{de} directly.

In step 110, the current value of the step size of the frequency compensation step S_{fc} can be gradually decreased or reduced by half to derive the frequency compensation step S_{fc} with the step size equal to the reduced value Vr. In addition, for clarity and simplicity illustrating the spirits of the present invention, the following embodiments of the present invention will be described in detail with reference to the accompanying drawings, and the current value of the step size of the frequency compensation step S_{fc} is reduced by half to derive the frequency compensation step S_{fc} with the step size equal to the reduced value Vr. It is to be noted, however, that the present invention is not limited thereto.

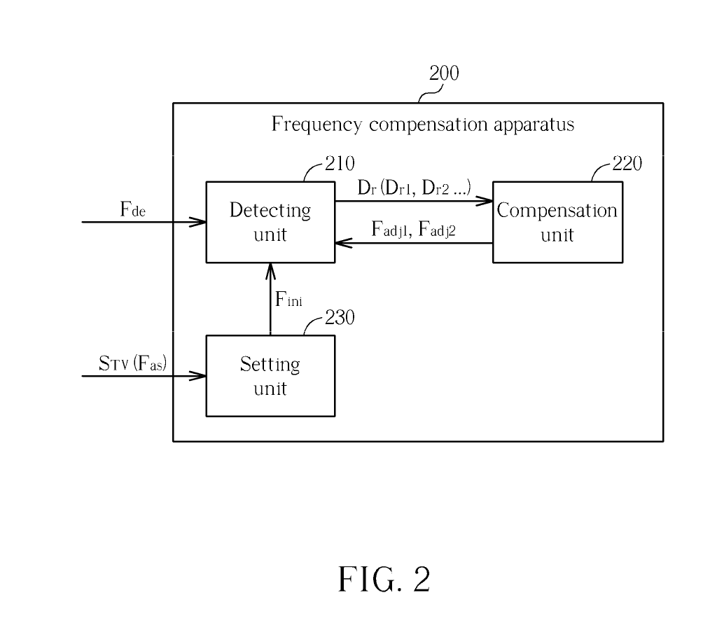

Please refer to FIG. 2. FIG. 2 is a diagram illustrating a frequency compensation apparatus 200 according to an exemplary embodiment of the present invention. The frequency compensation apparatus 200 includes, but is not limited to, a detecting unit 210, a compensation unit 220 and a setting unit 230. The detecting unit 210 is used for detecting and checking if the desired frequency F_{de} of an input signal (e.g., a television signal S_{TV}) falls within a first detectable frequency range R₁ delimited by the initial frequency Fᵢₙᵢ and a first specific frequency Fₛ₁ to generate a detecting result Dᵣ, wherein a size of the detectable frequency range R mentioned above is twice greater than that of the first detectable frequency range R₁. The compensation unit 220 is coupled to the detecting unit 210, and implemented for compensating the initial frequency Fᵢₙᵢ to the desired frequency F_{de} according to the detecting result Dᵣ generated by the detecting unit 210. When the detecting result Dᵣ (e.g., a first detecting result Dᵣ₁) indicates that the desired frequency F_{de} exceeds the first detectable frequency range R₁, the compensation unit 220 utilizes a first frequency compensation step S_{fc1} with a step size greater than the size of the first detectable frequency range R₁ (i.e., the frequency compensation step S_{fc} with the step size greater than the half size of the detectable frequency range R and equal to the default value Vd) for shifting the initial frequency Fᵢₙᵢ to a first adjusted frequency F_{adj1} beyond the first specific frequency Fₛ₁ in a first direction D₁; When the detecting result Dᵣ (e.g., the first detecting result Dᵣ₁) indicates that the desired frequency F_{de} falls within the first detectable frequency range R₁, the compensation unit 220 shifts the initial frequency Fᵢₙᵢ to the desired frequency F_{de} directly.

In this exemplary embodiment, the setting unit 230 is coupled to the detecting unit 210, and implemented for detecting an audio standard frequency Fₐₛ of the television signal S_{TV} and setting the audio standard frequency Fₐₛ as the initial frequency Fᵢₙᵢ in the first frequency compensation session of the frequency compensation procedure. After shifting the initial frequency Fᵢₙᵢ to the first adjusted frequency F_{adj1} according to the first detecting result Dᵣ₁, the detecting unit 210 further detects and checks if the desired frequency F_{de} falls within a second detectable frequency range R₂ delimited by the first adjusted frequency F_{adj1} and a second specific frequency Fₛ₂, thereby generating the detecting result Dᵣ (e.g., a second detecting result Dᵣ₂), wherein the size of the detectable frequency range R is also twice greater than that of the second detectable frequency range R₂. When the detecting result Dᵣ (e.g., the second detecting result Dᵣ₂) indicates that the desired frequency F_{de} exceeds the second detectable frequency range R₂, the compensation unit 220 utilizes a second frequency compensation step S_{fc2} (i.e., the frequency compensation step S_{fc} with the step size equal to the reduced value Vr), having a step size greater than a size of the second detectable frequency range R₂ and smaller than the step size of the first frequency compensation step S_{fc1}, for shifting the first adjusted frequency F_{adj1} to a second adjusted frequency F_{adj2} beyond the second specific frequency Fₛ₂ in a second direction D₂ opposite to the first direction D₁. When the detecting result Dᵣ (e.g., the second detecting result Dᵣ₂) indicates that the desired frequency F_{de} falls within the second detectable frequency range R₂, the compensation unit 220 shifts the first adjusted frequency F_{adj1} to the desired frequency F_{de} directly.

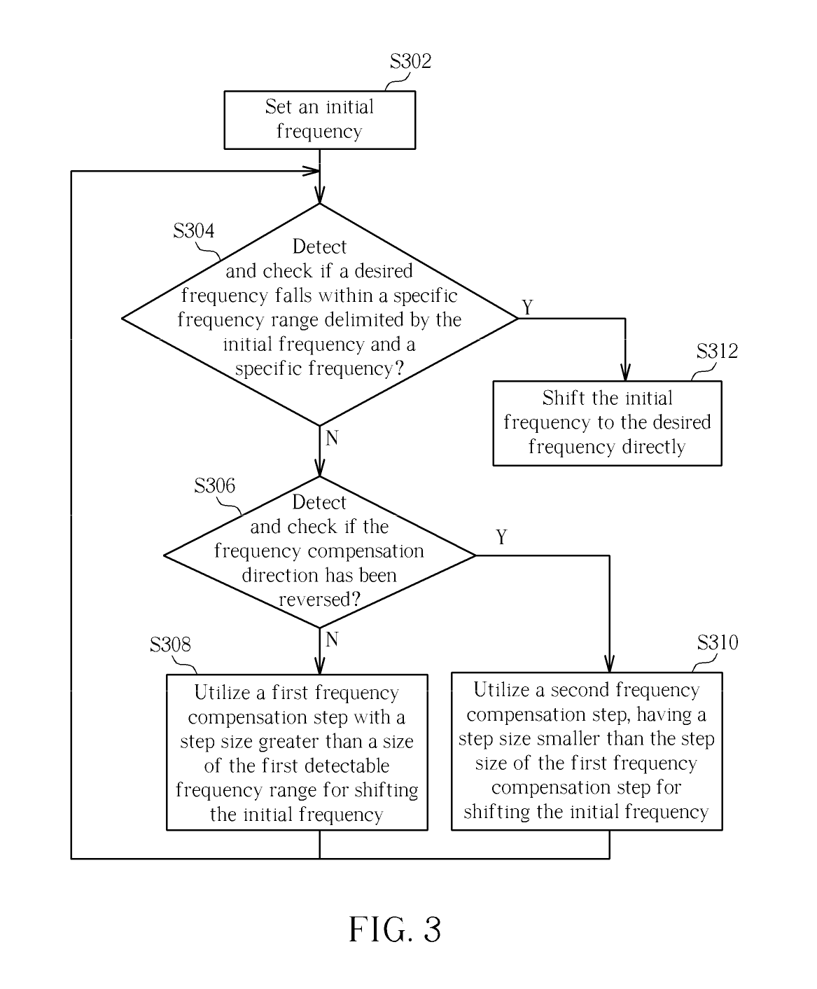

Please refer to FIG. 3. FIG. 3 is a flowchart illustrating a method for frequency compensation according to an exemplary embodiment of the present invention. Please note that, provided the same result is substantially achieved, the steps of the flow shown in FIG. 3 need not be in the exact order shown and need not be contiguous; that is, other steps can be intermediate. The exemplary method for frequency compensation includes the following steps:

Step 302: set an initial frequency Fᵢₙᵢ.

Step 304: detect and check if the desired frequency F_{de} falls within a specific detectable frequency range Rₛ (e.g., the first detectable frequency range R₁ or the second detectable frequency range R₂) delimited by the initial frequency Fᵢₙᵢ and a specific frequency Fₛ (e.g., the first specific frequency Fₛ₁ or the second specific frequency Fₛ₂). If yes, go to step 312; otherwise, go to step 306.

Step 306: detect and check if the frequency compensation direction D (e.g., D₁ and D₂) has been reversed. If yes, go to step 310; otherwise, go to step 308.

Step 308: utilize the first frequency compensation step S_{fc1} with a step size greater than the size of the first detectable frequency range R₁ for shifting the initial frequency Fᵢₙᵢ, and then go to step 304.

Step 310: utilize the second frequency compensation step S_{fc2}, having the step size smaller than the step size of the first frequency compensation step S_{fc1} for shifting the initial frequency Fᵢₙᵢ, and then go to step 304.

Step 312: shift the initial frequency Fᵢₙᵢ to the desired frequency F_{de} directly.

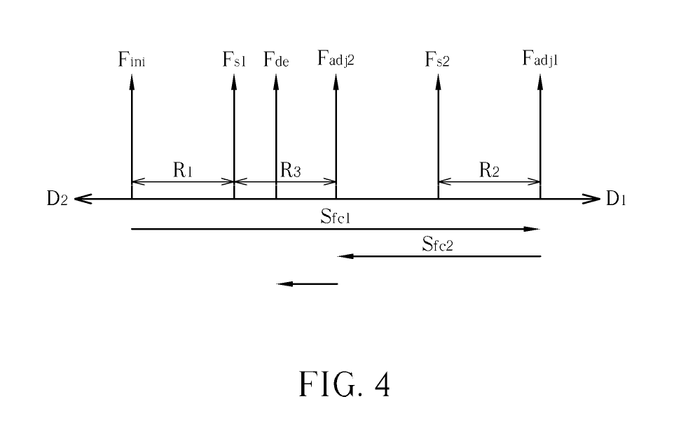

Please note that, for clarity and simplicity, the following embodiments of the present invention will be described in detail with reference to the accompanying drawings. It is to be noted, however, that the present invention is not limited thereto. Please refer to FIG. 4 in conjunction with FIG. 2 and FIG. 3. FIG. 4 is a sequence diagram illustrating a frequency compensation procedure according to a first exemplary embodiment of the present invention. In this embodiment, the first detectable frequency range R₁ is equal to the second detectable frequency range R₂ and a third detectable frequency range R₃, the step size of the first frequency compensation step S_{fc1} is four times as great as that of the first detectable frequency range R₁, and the step size of the first frequency compensation step S_{fc1} is twice that of the second frequency compensation step S_{fc2}, but these parameters should not be taken as limitations of the present invention. As shown in FIG. 4, the setting unit 230 executes step 302 to set the initial frequency Fᵢₙᵢ in the first frequency compensation session of the frequency compensation procedure. The detecting unit 210 executes step 304 to detect and check that the desired frequency F_{de} exceeds the first detectable frequency range R₁ delimited by the initial frequency Fᵢₙᵢ and the first specific frequency Fₛ₁ in a first direction D₁. The detecting unit 210 executes step 306 to check that the frequency compensation direction does not reverse. The compensation unit 220 executes step 308 to utilize the first frequency compensation step S_{fc1} for shifting the initial frequency Fᵢₙᵢ to the first adjusted frequency F_{adj1}. In the following second frequency compensation session of the frequency compensation procedure, the adjusted frequency F_{adj1} serves as an initial frequency, and the detecting unit 210 therefore executes step 304 to detect and check that the desired frequency F_{de} exceeds the second detectable frequency range R₂ delimited by the first adjusted frequency F_{adj1} and the second specific frequency Fₛ₂ in the second direction D₂. The detecting unit 210 executes step 306 to check that the frequency compensation direction is reversed. Thus, the compensation unit 220 executes step 310 to utilize the second frequency compensation step S_{fc2} for shifting the first adjusted frequency F_{adj1} to the second adjusted frequency F_{adj2}. In the following third compensation session of the frequency compensation procedure, the second adjusted frequency F_{adj2} serves as an initial frequency, and the detecting unit 210 executes step 304 to detect and check that the desired frequency F_{de} falls within the third detectable frequency range R₃ delimited by the second adjusted frequency F_{adj2} and the first specific frequency Fₛ₁ in the second direction D₂. The compensation unit 220 executes step 312 to shift the second adjusted frequency F_{adj2} to the desired frequency F_{de} directly, thereby accomplishing the frequency compensation procedure.

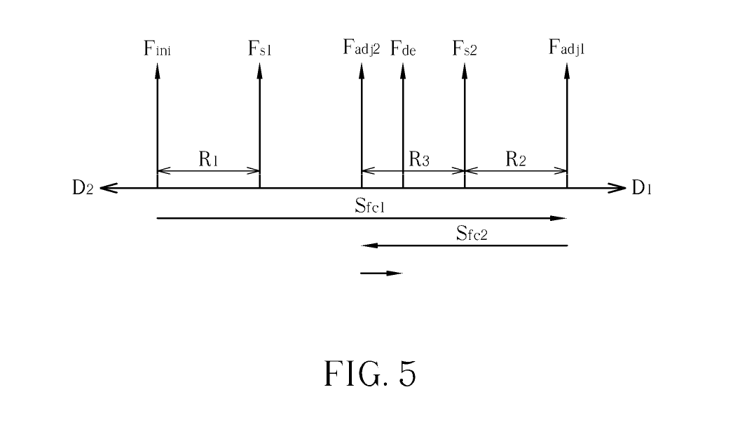

Please refer to FIG. 5 in conjunction with FIG. 2 and FIG. 3. FIG. 5 is a sequence diagram illustrating a frequency compensation procedure according to a second exemplary embodiment of the present invention. In this embodiment, the first detectable frequency range R₁ is equal to the second detectable frequency range R₂ and the third detectable frequency range R₃, the step size of the first frequency compensation step S_{fc1} is four times as great as that of the first detectable frequency range R₁, and the step size of the first frequency compensation step S_{fc1} is twice that of the second frequency compensation step S_{fc2}, but these parameters should not be taken as limitations of the present invention. As shown in FIG. 5, the setting unit 230 executes step 302 to set the initial frequency Fᵢₙᵢ in the first frequency compensation session of the frequency compensation procedure. The detecting unit 210 executes step 304 to detect and check that the desired frequency F_{de} exceeds the first detectable frequency range R₁ delimited by the initial frequency Fᵢₙᵢ and a first specific frequency Fₛ₁ in a first direction D₁. The detecting unit 210 executes step 306 to check that the frequency compensation direction does not reverse. The compensation unit 220 executes step 308 to utilize the first frequency compensation step S_{fc1} for shifting the initial frequency Fᵢₙᵢ to the first adjusted frequency F_{adj1}. In the following second frequency compensation session of the frequency compensation procedure, the first adjusted frequency F_{adj1} serves as an initial frequency, and the detecting unit 210 executes step 304 to detect and check that the desired frequency F_{de} exceeds the second detectable frequency range R₂ delimited by the first adjusted frequency F_{adj1} and the second specific frequency Fₛ₂ in the second direction D₂. The detecting unit 210 executes step 306 to check that the frequency compensation direction is reversed. Thus, the compensation unit 220 executes step 310 to utilize the second frequency compensation step S_{fc2} for shifting the first adjusted frequency F_{adj1} to the second adjusted frequency F_{adj2}. In the following third frequency compensation session of the frequency procedure, the second adjusted frequency F_{adj2} serves as an initial frequency, and the detecting unit 210 executes step 304 to detect and check that the desired frequency F_{de} falls within the third detectable frequency range R₃ delimited by the second adjusted frequency F_{adj2} and the second specific frequency Fₛ₂ in the first direction D₁. The compensation unit 220 executes step 312 to shift the second adjusted frequency F_{adj2} to the desired frequency F_{de} directly, thereby accomplishing the frequency compensation procedure.

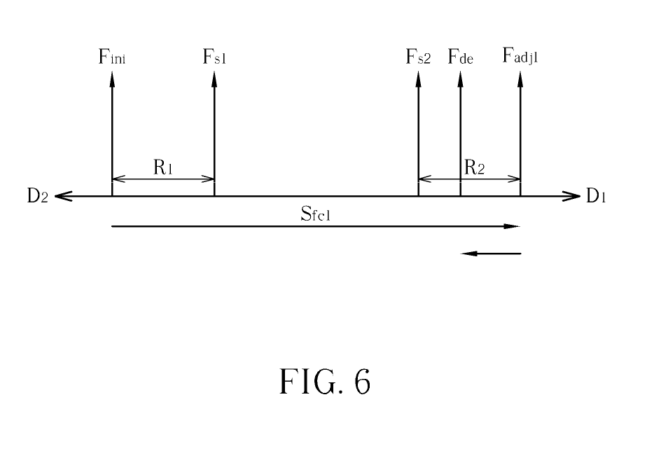

Please refer to FIG. 6 in conjunction with FIG. 2 and FIG. 3. FIG. 6 is a sequence diagram illustrating a frequency compensation procedure according to a third exemplary embodiment of the present invention. In this embodiment, the first detectable frequency range R₁ is equal to the second detectable frequency range R₂, and the step size of the first frequency compensation step S_{fc1} is four times as great as that of the first detectable frequency range R₁, but these parameters should not be taken as limitations of the present invention. As shown in FIG. 6, the setting unit 230 executes step 302 to set the initial frequency Fᵢₙᵢ in the first frequency compensation session of the frequency compensation procedure. The detecting unit 210 executes step 304 to detect and check that the desired frequency F_{de} exceeds the first detectable frequency range R₁ delimited by the initial frequency Fᵢₙᵢ and a first specific frequency Fₛ₁ in a first direction D₁. The detecting unit 210 executes step 306 to check that the frequency compensation direction does not reverse. The compensation unit 220 executes step 308 to utilize the first frequency compensation step S_{fc1} for shifting the initial frequency Fᵢₙᵢ to the first adjusted frequency F_{adj1}. In the following second frequency compensation session of the frequency compensation procedure, the first adjusted frequency F_{adj1} serves as an initial frequency, and the detecting unit 210 executes step 304 to detect and check that the desired frequency F_{de} falls within the second detectable frequency range R₂ delimited by the first adjusted frequency F_{adj1} and the second specific frequency Fₛ₂ in the second direction D₂. The compensation unit 220 executes step 312 to shift the first adjusted frequency F_{adj1} to the desired frequency F_{de} directly, thereby accomplishing the frequency compensation procedure.

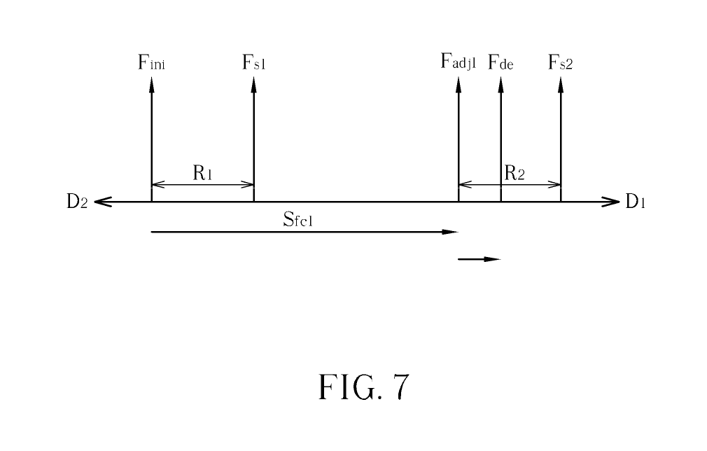

Please refer to FIG. 7 in conjunction with FIG. 2 and FIG. 3. FIG. 7 is a sequence diagram illustrating a frequency compensation procedure according to a fourth exemplary embodiment of the present invention. In this embodiment, the first detectable frequency range R₁ is equal to the second detectable frequency range R₂, and the step size of the first frequency compensation step S_{fc1} is four times as great as that of the first detectable frequency range R₁, but these parameters should not be taken as limitations of the present invention. As shown in FIG. 7, the setting unit 230 executes step 302 to set the initial frequency Fᵢₙᵢ in the first frequency compensation session of the frequency compensation procedure. The detecting unit 210 executes step 304 to detect and check that the desired frequency F_{de} exceeds the first detectable frequency range R₁ delimited by the initial frequency Fᵢₙᵢ and a first specific frequency Fₛ₁ in a first direction D₁. The detecting unit 210 executes step 306 to check that the frequency compensation direction does not reverse. The compensation unit 220 executes step 308 to utilize the first frequency compensation step S_{fc1} for shifting the initial frequency Fᵢₙᵢ to the first adjusted frequency F_{adj1}. In the following second frequency compensation session of the frequency compensation procedure, the first adjusted frequency F_{adj1} serves as an initial frequency, and the detecting unit 210 executes step 304 to detect and check that the desired frequency F_{de} falls within the second detectable frequency range R₂ delimited by the first adjusted frequency F_{adj1} and the second specific frequency Fₛ₂ in the first direction D₁. The compensation unit 220 executes step 312 to shift the first adjusted frequency F_{adj1} to the desired frequency F_{de} directly, thereby accomplishing the frequency compensation procedure.

As can be seen from FIG. 4 through FIG. 7, the exemplary frequency compensation apparatus 200 of the present invention is allowed to utilize a frequency compensation step with a step size greater than that of the detectable frequency range, such as R1, R2 or R3, to compensate the initial frequency. However, in the prior art design, the conventional frequency compensation apparatus can only compensate the initial frequency with a step size smaller than or equal to the detectable frequency range. Therefore, if the initial frequency is located far from the desired frequency, the frequency compensation apparatus 200 can compensate the initial frequency with a flexible frequency compensation step, decreasing the compensation time greatly.

The abovementioned embodiments are presented merely for describing features of the present invention, and in no way should be considered to be limitations of the scope of the present invention. In other words, the exemplary frequency compensation procedures shown in FIGS. 4-7 are for illustrative purposes only.

In summary, exemplary embodiments of the present invention provide a frequency compensation method which can compensate a frequency in a flexible manner, and a related apparatus. By utilizing a flexible frequency compensation step with a step size greater than the size of the detectable frequency range, the exemplary frequency compensation apparatus of the present invention can compensate the initial frequency quickly when the initial frequency is located far from the desired frequency, leading to improved frequency compensation performance.

Those skilled in the art will readily observe that numerous modifications and alterations of the device and method may be made while retaining the teachings of the invention.

What is claimed is:

1. A method for frequency compensation, comprising:
detecting and checking if a desired frequency falls within a first detectable frequency range delimited by an initial frequency and a first specific frequency; and
when the desired frequency exceeds the first detectable frequency range, utilizing a first frequency compensation step with a step size greater than a size of the first detectable frequency range for shifting the initial frequency to a first adjusted frequency beyond the first specific frequency in a first direction.

2. The method of claim 1, further comprising:
when the desired frequency falls within the first detectable frequency range, shifting the initial frequency to the desired frequency directly.

3. The method of claim 1, further comprising:
detecting an audio standard frequency of a television signal; and
setting the audio standard frequency as the initial frequency.

4. The method of claim 1, further comprising:
detecting and checking if the desired frequency falls within a second detectable frequency range delimited by the first adjusted frequency and a second specific frequency; and
when the desired frequency exceeds the second detectable frequency range, utilizing a second frequency compensation step, having a step size greater than a size of the second detectable frequency range and smaller than the step size of the first frequency compensation step, for shifting the first adjusted frequency to a second adjusted frequency beyond the second specific frequency in a second direction opposite to the first direction.

5. The method of claim 4, further comprising:
when the desired frequency falls within the second detectable frequency range, shifting the first adjusted frequency to the desired frequency directly.

6. A frequency compensation apparatus, comprising:
a detecting unit, for detecting and checking if a desired frequency falls within a first detectable frequency range delimited by an initial frequency and a first specific frequency to generate a first detecting result; and
a compensation unit, coupled to the detecting unit, for compensating the initial frequency to a first adjusted frequency according to the first detecting result generated by the detecting unit, wherein when the first detecting result indicates that the desired frequency exceeds the first detectable frequency range, the compensation unit utilizes a first frequency compensation step with a step size greater than a size of the first detectable frequency range for shifting the initial frequency to the first adjusted frequency beyond the first specific frequency in a first direction.

7. The frequency compensation apparatus of claim 6, wherein when the first detecting result indicates that the desired frequency falls within the first detectable frequency range, the compensation unit shifts the initial frequency to the desired frequency directly.

8. The frequency compensation apparatus of claim 6, further comprising:
a setting unit, coupled to the detecting unit, for detecting an audio standard frequency of a television signal and setting the audio standard frequency as the initial frequency.

9. The frequency compensation apparatus of claim 6, wherein the detecting unit further detects and checks if the desired frequency falls within a second detectable frequency range delimited by the first adjusted frequency and a second specific frequency to generate a second detecting result; and when the second detecting result indicates that the desired frequency exceeds the second detectable frequency range, the compensation unit utilizes a second frequency compensation step, having a step size greater than a size of the second detectable frequency range and smaller than the step size of the first frequency compensation step, for shifting the first adjusted frequency to a second adjusted frequency beyond the second specific frequency in a second direction opposite to the first direction.

10. The frequency compensation apparatus of claim 9, wherein when the second detecting result indicates that the desired frequency falls within the second detectable frequency range, the compensation unit shifts the first adjusted frequency to the desired frequency directly.

11. A method for frequency compensation, comprising:
(a) detecting and checking if a desired frequency falls within a detectable frequency range, wherein an initial frequency is located at a center of the detectable frequency range; and
(b) when the desired frequency exceeds the detectable frequency range, utilizing a frequency compensation step with a step size greater than a half size of the detectable frequency range for updating the initial frequency by shifting the initial frequency to an adjusted frequency.

12. The method of claim 11, wherein step (b) comprises:
when the desired frequency exceeds the detectable frequency range, detecting if a current frequency compensation direction needs to be reversed;
when it is detected that the current frequency compensation direction does not need to be reversed, utilizing the frequency compensation step with the step size equal to a default value for shifting the initial frequency to the adjusted frequency; and
when it is detected that the current frequency compensation direction needs to be reversed, reducing a current value of the step size of the frequency compensation step, and then utilizing the frequency compensation step with the step size equal to a reduced value for shifting the initial frequency to the adjusted frequency.

13. The method of claim 12, wherein the current value of the step size of the frequency compensation step is gradually decreased to derive the frequency compensation step with the step size equal to the reduced value.

14. The method of claim 12, wherein the current value of the step size of the frequency compensation step is reduced by half to derive the frequency compensation step with the step size equal to the reduced value.

15. The method of claim 12, wherein steps (a) and (b) are sequentially and repeatedly executed until the desired frequency falls within the detectable frequency range.

16. The method of claim 15, further comprising:
when the desired frequency falls within the detectable frequency range, shifting the initial frequency to the desired frequency directly.

17. The method of claim 11, further comprising:
when the desired frequency falls within the detectable frequency range, shifting the initial frequency to the desired frequency directly.
